(19) United States
(12) Patent Application Publication
(10) Pub. No.: US 2017/0082186 A1
(43) Pub. Date: Mar. 23, 2017

(54) AXLE ASSEMBLY

(71) Applicant: GM Global Technology Operations LLC, Detroit, MI (US)

(72) Inventors: FAWAZ ELZIB, WINDSOR (CA); MUFTAU M. ALABI, ROCHESTER HILLS, MI (US); DAVID S. SCHULZ, LIVONIA, MI (US); BHAPINDER PURI, TROY, MI (US)

(21) Appl. No.: 14/861,460

(22) Filed: Sep. 22, 2015

(51) Int. Cl. F16H 48/42; F16H 48/08

(52) U.S. Cl. CPC F16H 48/42; F16H 48/08; F16H 2048/423

(57) ABSTRACT

An axle housing for an axle assembly of a vehicle includes a pinion portion and a differential portion. The differential portion rotatably supports a differential gear assembly. A pinion insert has a first and second bearing pockets and is disposed in the pinion portion of the axle housing at least partially forming a bore through which a pinion shaft rotates. A first bearing is disposed in the first bearing pocket of the pinion insert and a second bearing is disposed in the second bearing pocket of the pinion insert. The pinion insert is manufactured from a material having a higher stiffness than the cast metal alloy of the axle housing.

### TECHNICAL FIELD

The present disclosure relates to drivetrain and more particularly to an axle assembly.

### BACKGROUND

The statements in this section merely provide background information related to the present disclosure and may or may not constitute prior art.

A typical axle assembly includes an axle housing manufactured using a cast metal process incorporating a cast iron alloy material. Cast iron incorporates good material properties for the application of an axle housing. However, under constant desire to achieve improved fuel economy, designers and engineers are left seeking lighter weight alternative materials while maintaining the ideal mechanical characteristics and performance of cast iron.

While current axle assemblies and housings achieve their intended purpose, the need for new and improved axle assemblies and housings which exhibit improved performance, especially from the standpoints of efficiency, reduced size and weight, and NVH improvements, is constant. Accordingly, there is a need in the art for an axle assembly and housing having improved stiffness and weight reduction.

### SUMMARY

The present invention provides an axle assembly for a vehicle. The axle assembly includes an axle housing, a differential gear assembly, a pinion shaft, and a pinion insert. The axle housing includes a pinion portion and a differential portion. The differential gear assembly is rotatably supported by the differential portion of the axle housing. The pinion shaft is connected to a vehicle drive shaft to transmit torque from a transmission of a vehicle. The pinion shaft includes a pinion gear meshing with the ring gear. The pinion shaft is rotatably supported by the pinion portion of the axle housing through a first and second bearings. The pinion insert has a first and second bearing pockets. The pinion insert is disposed in the pinion portion of the axle housing at least partially forming a bore through which the pinion shaft rotates. The first bearing is disposed in the first bearing pocket of the pinion insert. The second bearing is disposed in the second bearing pocket of the pinion insert.

In another example of the present invention, the differential assembly includes a ring gear, a differential case connected for common rotation with the ring gear, a first and second pinion gears rotatably supported by the differential case, and a first and second side gears meshing with the pinion gears.

In yet another example of the present invention, the pinion insert further includes an outer diameter surface having an anti-rotation feature.

In yet another example of the present invention, the anti-rotation feature of the pinion insert includes a plurality of dimples.

In yet another example of the present invention, the anti-rotation feature of the pinion insert includes a knurled textured surface.

In yet another example of the present invention, the axle housing is manufactured from a cast aluminum alloy.

In yet another example of the present invention, the pinion insert is manufactured from a cast iron alloy.

In yet another example of the present invention, the pinion insert is manufactured from a high strength and high stiffness material.

In yet another example of the present invention, the axle housing is manufactured by placing the pinion insert in a cast mold prior to pouring a liquid cast metal alloy to form the axle housing.

The above features and advantages and other features and advantages of the present invention are readily apparent from the following detailed description of the best modes for carrying out the invention when taken in connection with the accompanying drawings.

### BRIEF DESCRIPTION OF THE DRAWING

FIG. 1 is a perspective cutaway view of a axle assembly in accordance with the present invention;

FIG. 2 is a cross section of a portion of a axle assembly, in accordance with the present invention;

FIG. 3 is a plan view of a axle housing having a partial transparent portion, in accordance with the present invention;

FIG. 4 is an end view of a axle housing, in accordance with the present invention;

FIG. 5 is a cross section of a portion of a axle housing, in accordance with the present invention;

FIG. 6 is a perspective view of a housing insert for an axle housing, in accordance with the present invention; and

FIG. 7 is an end view of a housing insert for an axle housing, in accordance with the present invention.

### DESCRIPTION

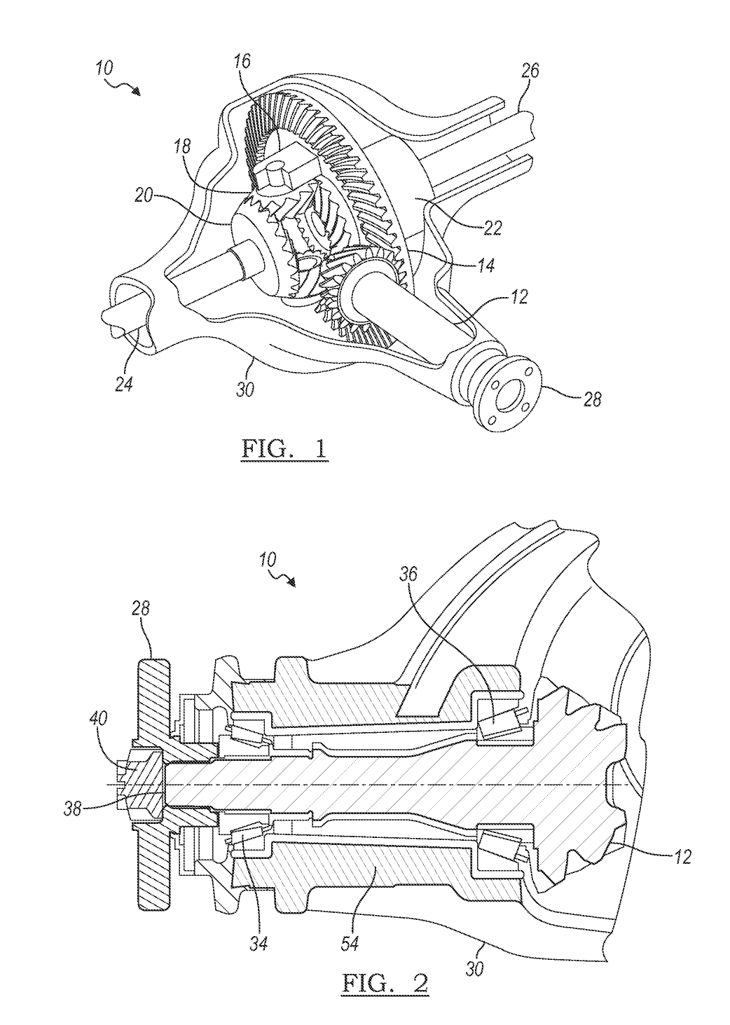

Referring to FIG. 1, a drivetrain axle assembly, generally indicated by reference number 10 is illustrated and will now be described. The axle assembly 10 includes a drive or pinion shaft 12, a differential drive ring gear 14, a differential case 16, a pair of differential pinion gears 18, a first and a second side gears 20, 22, a first and second axle shafts 24, 26, a drive shaft flange 28, and an axle housing 30. For example, the pinion shaft 12 is rotatably supported in the axle housing 30 and includes a pinion gear 32 meshed with the differential drive ring gear 14. The pinion shaft 12 is interconnected for common rotations with a drive shaft (not shown) from a transmission. The differential drive ring gear 14 is interconnected for common rotation with the differential case 16 which carries the pinion gears 18 in mesh with the first and second side gears 20, 22. The first and second side gears 20, 22 are interconnected for common rotation with the first and second axle shafts 24, 26, respectively. Other gearing arrangements of the axle assembly 10 or additional mechanisms such as clutches, etc. may be included without departing from the scope of the invention.

Turning now to FIG. 2 with continuing reference to FIG. 1, a portion of the axle assembly 10 is illustrated and will now be described. The axle assembly 10 further includes a first and second tapered roller bearings 34, 36. More specifically, the pinion shaft 12 is rotatably supported in the axle housing 30 via the first and second bearings 34, 36. The drive shaft flange 28 is fastened to a first end 38 of the pinion shaft 12 with a threaded fastener and nut assembly 40.

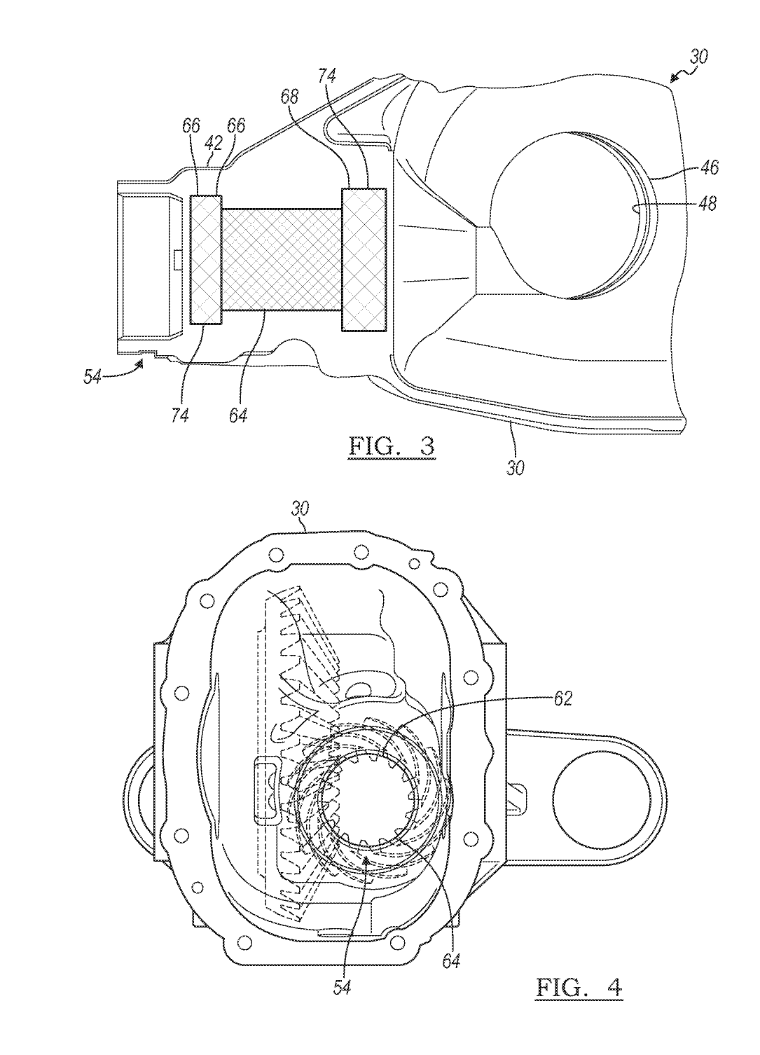

Turning now to FIGS. 3, 4 and 5 with continuing reference to FIG. 2, the axle housing 30 of the axle assembly 10 is illustrated and will now be described. The axle housing 30 is manufactured through a cast metal process. For example, the axle housing 30 may be manufactured from a cast aluminum process, however, other metals and process may be utilized without departing from the scope of the invention. The axle housing 30 includes a drive or pinion portion 42, a gearing or differential portion 44, and a first and second axle shaft bores 46, 48. The pinion portion 42 extends from the differential portion 44 while the axle shaft bores 46, 48 are disposed in opposite sides of the differential portion 44. The pinion portion 42 includes a bore 50 having an inner surface 52. In one example of the present invention, the pinion portion 42 further includes a cylindrically shaped pinion bore insert 54. The insert 54 forms a portion of the bore 50 and inner surface 52. The insert 54 includes a first end 56, a second end 58, a first bearing pocket 60, a second bearing pocket 62, and a center bore 64. More specifically, the first bearing pocket 60 is disposed at the first end 56 of the insert 54 and the second bearing pocket 62 is disposed at the second end 58 of the insert 54 which is opposite the first end 56 and adjacent to the differential portion 44 of the axle housing 30. The first bearing 34 is disposed in the first bearing pocket 60 and the second bearing 36 is disposed in the second bearing pocket 62. The pinion shaft 12 is rotatably supported by the first and second bearings 34, 36.

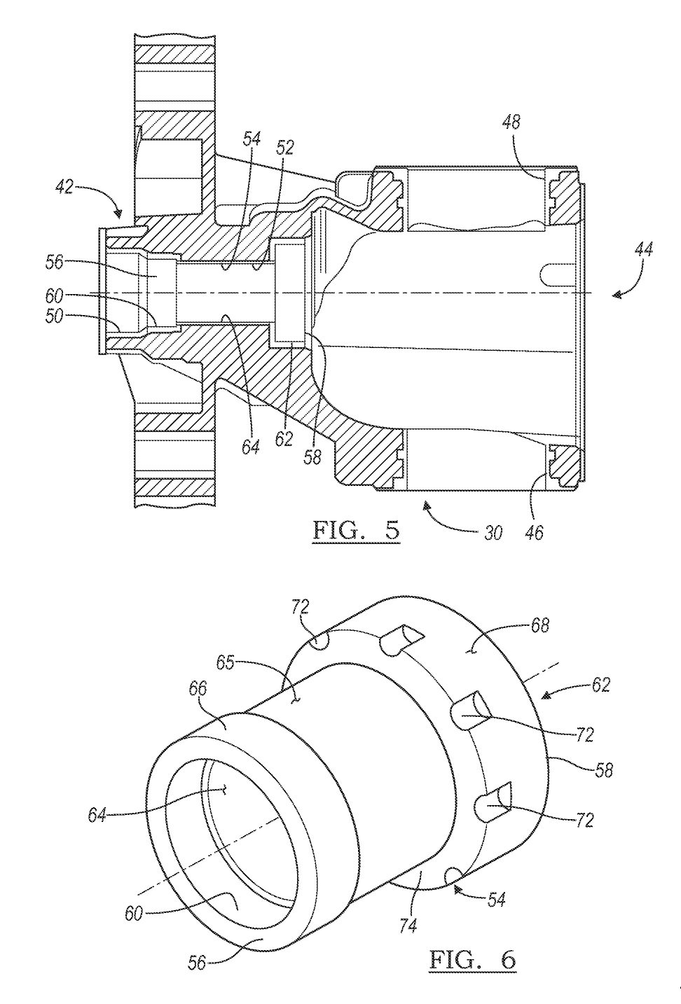

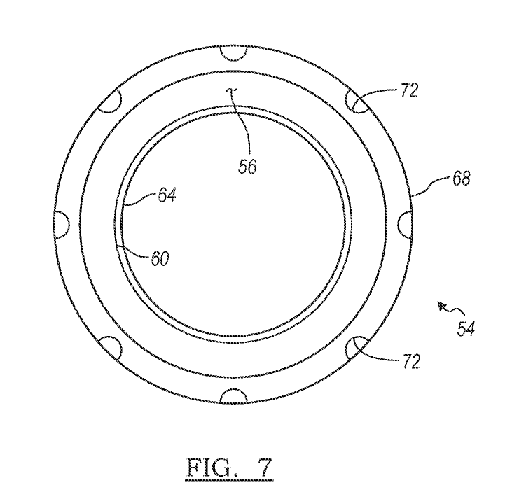

Referring now to FIGS. 6 and 7 with continuing reference to FIGS. 2-5, the insert 54 is illustrated and will now be described. The insert 54 further includes an outer surface 65 having a first portion 66 and a second portion 68. More specifically, the first portion 66 of the outer surface 65 is the outside diametrical surface proximate the first end 56 of the insert 54 and is axially adjacent to the first bearing pocket 60. The second portion 68 of the outer surface 65 is the outside diametrical surface proximate the second end 58 of the insert 54 and is axially adjacent to the second bearing pocket 62. The outer surface 65 further includes an anti-rotation feature 70 that prevents the insert 54 from rotating during operation. For example, the anti-rotation feature 70 of the insert 54 shown in FIG. 5 is a plurality of dimples or divots 72. The dimples 72 are disposed at a surface transition 74 at the second portion 68 of the outer surface 65. During the casting process of the housing 30, liquid metal fills the dimples 72 and freezes to create a mechanical locking structure to interfere with the rotation of the insert 54 thus locking the insert 54 into position. In another example shown in FIG. 3, the insert 54 includes an anti-rotation feature 70 as a knurled or textured surface 74. The insert 54 may be manufactured of a number of materials and processes without departing from the scope of the invention. For example, the insert 54 may be machined from stock steel, cast and machined from iron or other alloy, or formed from a metal composite. Regardless of the material the insert 54 is manufactured from, the insert 54 is ideally stiffer than the parent material of the axle housing.

While the best modes for carrying out the invention have been described in detail, those familiar with the art to which this invention relates will recognize various alternative designs and examples for practicing the invention within the scope of the appended claims.

The following is claimed:

1. An axle assembly for a vehicle, the axle assembly comprising:
an axle housing including a pinion portion and a differential portion;
a differential gear assembly rotatably supported by the differential portion of the axle housing;
a pinion shaft connected to a vehicle drive shaft to transmit torque from a transmission of a vehicle, and wherein the pinion shaft includes a pinion gear drivingly meshing with the differential gear assembly and the pinion shaft is rotatably supported by the pinion portion of the axle housing through a first and second bearings, and
a pinion insert having a first and second bearing pockets, and wherein the pinion insert is disposed in the pinion portion of the axle housing at least partially forming a bore through which the pinion shaft rotates, the first bearing is disposed in the first bearing pocket of the pinion insert and the second bearing is disposed in the second bearing pocket of the pinion insert.

2. The axle housing of claim 1 wherein the differential assembly includes a ring gear, a differential case connected for common rotation with the ring gear, a first and second pinion gears rotatably supported by the differential case, and a first and second side gears meshing with the pinion gears.

3. The axle housing of claim 1 wherein the pinion insert further includes an outer diameter surface having an anti-rotation feature.

4. The axle housing of claim 3 wherein the anti-rotation feature of the pinion insert includes a plurality of dimples.

5. The axle housing of claim 3 wherein the anti-rotation feature of the pinion insert includes a knurled textured surface.

6. The axle housing of claim 1 wherein the axle housing is manufactured from a cast aluminum alloy.

7. The axle housing of claim 1 wherein the pinion insert is manufactured from a cast iron alloy.

8. The axle housing of claim 1 wherein the pinion insert is manufactured from a high strength and high stiffness material.

9. The axle housing of claim 1 wherein axle housing is manufactured by placing the pinion insert in a die cast mold prior to pouring a liquid cast metal alloy to form the axle housing.

10. An axle assembly for a vehicle, the axle assembly comprising:
an axle housing including a pinion portion and a differential portion;
a differential gear assembly rotatably supported by the differential portion of the axle housing, and wherein the differential gear assembly includes a ring gear, a differential case connected for common rotation with the ring gear, a first and second pinion gears rotatably supported by the differential case, and a first and second side gears meshing with the pinion gears;
a pinion shaft connected to a vehicle drive shaft to transmit torque from a transmission of a vehicle, and wherein the pinion shaft includes a pinion gear drivingly meshing with the ring gear of the differential gear assembly and the pinion shaft is rotatably supported by the pinion portion of the axle housing through a first and second bearings, and
a pinion insert having a first and second bearing pockets, and wherein the pinion insert is disposed in the pinion portion of the axle housing at least partially forming a bore through which the pinion shaft rotates, the first bearing is disposed in the first bearing pocket of the pinion insert and the second bearing is disposed in the second bearing pocket of the pinion insert.

11. The axle housing of claim 10 wherein the pinion insert further includes an outer diameter surface having a plurality of dimples to prevent relative rotation between the axle housing and the pinion insert.

12. The axle housing of claim 10 wherein the pinion insert further includes an outer diameter surface having includes a knurled textured surface to prevent relative rotation between the axle housing and the pinion insert.

13. The axle housing of claim 10 wherein the axle housing is manufactured from a cast aluminum alloy.

14. The axle housing of claim 13 wherein the pinion insert is manufactured from a cast iron alloy.

15. The axle housing of claim 10 wherein the pinion insert is manufactured from a high strength and high stiffness material.

16. The axle housing of claim 10 wherein axle housing is manufactured by placing the pinion insert in a cast mold prior to pouring the metal to form the axle housing.

17. An axle housing for an axle assembly of a vehicle, the axle housing comprising:
a pinion portion and a differential portion, the differential portion rotatably supporting a differential gear assembly;
a pinion insert having a first and second bearing pockets, and wherein the pinion insert is disposed in the pinion portion of the axle housing at least partially forming a bore through which a pinion shaft of the axle assembly rotates, and
a first bearing and a second bearing, and wherein the first bearing is disposed in the first bearing pocket of the pinion insert and the second bearing is disposed in the second bearing pocket of the pinion insert; and
wherein the axle housing is manufactured by placing the pinion insert in a cast mold prior to pouring a liquid cast metal alloy to form the axle housing, the pinion insert is manufactured from a material having a higher stiffness than the cast metal alloy of the axle housing, and the pinion shaft of the axle assembly is rotatably supported by the bearings.

18. The axle housing of claim 17 wherein the pinion insert further includes an outer diameter surface having a plurality of dimples to prevent relative rotation between the axle housing and the pinion insert.

19. The axle housing of claim 17 wherein the pinion insert further includes an outer diameter surface having includes a knurled textured surface to prevent relative rotation between the axle housing and the pinion insert.

20. The axle housing of claim 17 wherein the axle housing is manufactured from a cast aluminum alloy and the pinion insert is manufactured from a cast iron alloy.
